(19) United States
(12) Patent Application Publication
(10) Pub. No.: US 2019/0021299 A1
(43) Pub. Date: Jan. 24, 2019

(54) DEVICE AND METHOD FOR RAPIDLY CHANGING THE APPEARANCE OF A FISHING LURE

(71) Applicant: Crank Wraps, LLC, Springfield, MO (US)

(72) Inventor: Richard Willard Fishback, JR., Springfield, MO (US)

(21) Appl. No.: 16/040,618

(22) Filed: Jul. 20, 2018

Related U.S. Application Data
(60) Provisional application No. 62/535,807, filed on Jul. 21, 2017.

(51) Int. Cl. A01K 85/00; C09J 7/29; C09J 7/20

(52) U.S. Cl. CPC A01K 85/00; C09J 7/29; C09J 2400/28; C09J 2205/106; C09J 2423/006; C09J 7/201

(57) ABSTRACT

The present disclosure relate to a device and method for changing the appearance of a fishing lure. The device is an image printed on a vinyl product with adhesive backing. Once the image is printed on the vinyl the image is scored and removed. It is then adhered to the side of a hard bodied fishing lure. For some lures, a mirror image graphic is adhered to the opposite side of the lure. The vinyl images can be removed and reused several times.

### CROSS REFERENCE TO RELATED APPLICATIONS

This application claims priority to U.S. Provisional Application No. 62/535,807, filed Jul. 21, 2017, the disclosure of which are incorporated by reference herein in its entirety.

### BACKGROUND

The present invention relates to a novel device and method for rapidly changing the appearance of a fishing lure. More particularly, the device facilitates rapidly changing the appearance of hard lures, such as crankbaits or spoons without removing the lure from connected fishing line.

There are hundreds, if not thousands, of different hard bodied lures available in the market. These lures have different body configurations, sizes and colors. For example, a specific hard lure mimics a crayfish. That lure may generally be available in the marketplace in thirty different color tones. If that lure is also provided in three different sizes, an angler would have to buy a total of ninety lures to have every permutation of that lure in their tackle boxes. So if that angler wanted ten different lures in every available size and color, they would have to buy hundreds of lures. As every angler knows, desirable hard bodied lures can be quite expensive with prices ranging from five to twenty-five dollars per lure. The same holds true for spoons which come in numerous sizes and colors.

Generally, crankbaits are manufactured from wood, hard plastics or combinations of plastic and metal. Spoons are usually made from metal. Both of these lure types are decorated by painting images onto the body of the bait. Many modern lures have color molded plastic bodies with images applied onto the molded body. Many lures include features of animals such as eyes, fins, antenna, legs and the like.

A flat, durable vinyl material with specific characteristics can be applied to and removed multiple times to a hard bodied lure without damage to the lure or the vinyl material. Application and removal do not require any specialized knowledge or tools. Moreover, the vinyl material used is highly adaptable for colorization, printing and texturing. Multiple realistic images can be provided on the planar vinyl material to mimic specific baitfish, insects, amphibians, reptiles or other aquatic animals that are attractive to feeding game fish. The fisherman is provided with a palette or different colors, hues and shades to select.

Using the example from above, the crayfish lure has ninety permutations and the angler would have to buy each of those lures. A careful angler might buy more than one of the lures in the color and size that are particularly attractive to their specific fishing requirements. Nothing is worse than finding a hot bait that the fish are craving to then lose the only one of those baits that you have. Many professional fisherman will have available to them a dozen or more of what they hope to be the lure of choice for the fish. As noted, this is expensive and requires substantial storage capacity for the lures.

The instant invention overcomes these drawbacks and limitations by providing an innovative sheet of images that can easily be applied to a hard bait to change the color, patterns, animal species or other characteristics of the lure. For example, the ninety variations of the crayfish lure can be reduced to three baits, one of each size. The color, hue and patterns of the thirty variations are printed on the vinyl sheet and the image cut so that it can be peeled from the sheet of vinyl. It is preferred that each printed bait image is provided in pairs with one image for each side of the lure. The process of removing the image from the backing is similar to removing a decorative sticker from backing.

One printed image is applied to each side of a lure. The properties of the vinyl material onto which the image is printed allow the material to securely adhere to the hard plastic of the lure. Surprisingly, the material does not come off as the lure is pulled through the water and is very resilient. It will survive many encounters with fish biting the lure and is generally resistant to being removed during use. The image is easily removed from the hard bodied lure by quickly applying heat to the lure which will cause the material to peel away from the lure. It has been found that quick exposure to a flame, such as a match or lighter, works well. The images can be reused many times.

### SUMMARY

Embodiments of the present disclosure relate to a product and method for rapidly changing the appearance of a fishing lure. The image from an existing lure body can be replicated by printing it on flat, planar material, preferably made from a vinyl product adhered to a paper backing. Otherwise, new artwork can be developed with the desired colors, hues and bait characteristics for application onto an existing lure body. It is preferred that the image be hyper-realistic and created from detailed photographs or other artistic methods. The size of the image should be proportionate to the size of the lure to which the image will be applied. In the preferred embodiment, a lure is selected for size, contours and features. The features will include the number of hooks and how they are fastened to the body of the lure, a diving bill, the fishing line fastening point and orientation, all such features generally affecting the movement of the lure in the water. Once the lure has been selected, an artist creates an image to apply to the bait. The image is applied to the vinyl material using conventional means, such as spray droplet printing. Any available method can be used to transfer the artist's images to the vinyl material.

Once the image is applied to the vinyl material it is die cut about the periphery of the image so that the vinyl with the artistic image can be removed from the paper backing. Once an image is created it is straight forward to replicate the image using computer generated graphics. Moreover, the image is easily manipulated to change the color, contrast, hue and other characteristics of the image.

Multiple images can be provided on a single sheet of the vinyl material. It is preferred that an entire color palette is provided for a specific lure. For example, one popular lure among fisherman is the Strike King KVD-1-5-Flat Side. This particular lure is provided in several color patterns and it would be necessary for an angler to buy each multiples of each lure color to have the entire spectrum of colors and configurations available to them. The inventive device and method allows every color pattern and configuration for the lure to be printed on a single sheet of vinyl material. The fisherman can then quickly change between colors and patterns without removing the lure from the fishing line by simply selecting the desired color and pattern, removing the two printed panels from the vinyl sheet and applying them to either side of the lure.

Traditionally, selecting a different colored lure would require cutting the fishing line and tying on the newly selected lure. With the invention, however, the lure does not have to be removed and color change is very quick. This speed of change is particularly important in competitive fishing tournaments where every second counts. It is common to see competitive fishermen with a dozen or more rods, each bearing a different lure or color combination of lures so that they do not have to take a lot of time tying on new lure patterns in an effort to determine which lure pattern is attractive to the fish at that time on that day.

While it is preferred that the printed images are configured for specific lure bodies, it is understood that the images can also be provided in configurations that can be applied to lures of varying sizes and shapes. For example, a round, oval or rectangular image can be created for application to a lure to add an area of color differentiation or to add an area of flash or sparkle. A brightly colored image could be applied to a dark bodied lure to create extra flash as the lure is moved through the water.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1 illustrates a printed lure image for application to a hard bodied fishing lure.

FIG. 2 illustrates a lure as provided by a manufacturer.

FIG. 3 illustrates the lure shown in FIG. 2 with an inventive vinyl image applied thereto.

FIG. 4 illustrates a fishing spoon image.

FIG. 5 illustrates spoon lures with inventive vinyl images applied

FIG. 6 illustrates a lure displayed with a variety of graphic images applied.

### DETAILED DESCRIPTION

Referring now generally to the figures, an inventive device and method for changing the appearance of a fishing lure is shown and will be described herein. A hard bodied fishing lure is selected, preferably formed from plastic, wood or metal. An image is drawn, painted, or otherwise created from photographs or computer imagery that generally depicts an animal or object to attract fish. The image may be a substantial replication of the image or appearance of the selected fishing lure or may be an originally created artwork. Generally, the image will be of a baitfish, insect, amphibian, crustacean, reptile or mammals that fish are known to eat. It is important that the image be proportionate to the lure being used.

It is anticipated that the images will be created for specific lures that are commonly available in the marketplace. The images created may replicate the color palette, hue, design, layout and appearance of the lure being used. For example, a single lure manufactured by any one of the large lure manufacturers may be available in dozens of colors and sizes. It is understood that the inventive method can be used to replicate the existing array of colors and images provided by the lure manufacturer or can be entirely new and originally created. Moreover, this process allows for more color variations and styles than generally available because of the substantial cost difference and space required for storage.

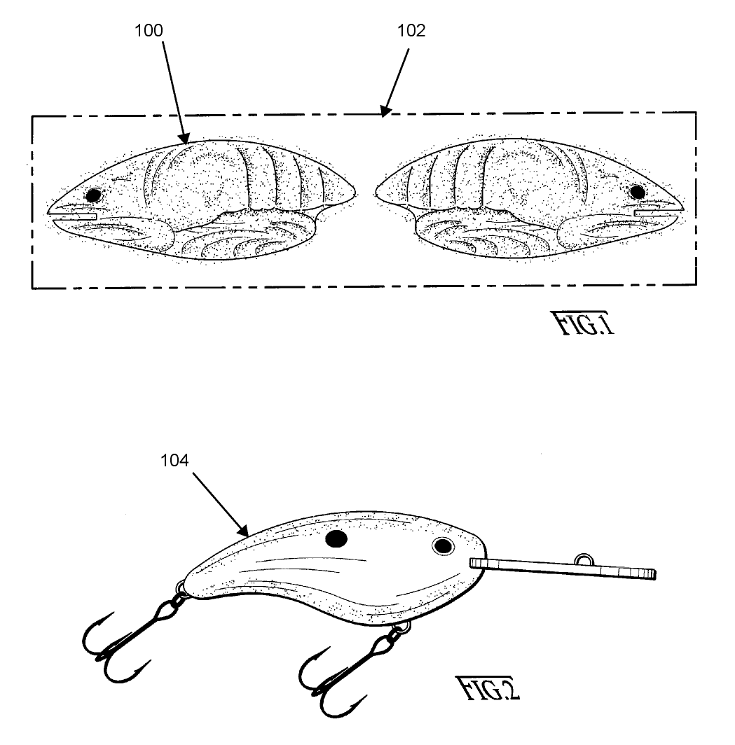

Because the images are created independently from the lure to which they will be applied, there is substantial control over the images compared to the types of images that can be molded into the lure body or applied to the lure surface during manufacturing. One method of creating the image is to photograph living animals, such as baitfish or insects and use the image to create electronic files for printing. The preferred method for creating an image is to use highly accurate and very realistic images of bait which are created by talented artists. As shown in the accompanying FIG. 1, a hand painted baitfish with realistic detail makes a very desirable image for decorating an fishing lure.

Once the image 100 has been created it is printed onto a sheet of vinyl material 102. The vinyl material is commercially available from a number of manufacturers and is the same type of vinyl commonly used to “wrap” or decorate automobiles. The preferred vinyl material is manufactured by 3M™ under a product line referred to as Controltac™. More specifically, the material is 3M™ Controltac™ Graphic Film, Series 180 with Comply™ Adhesive. Controltac™ is a vinyl product with pressure activated adhesive which is tacky enough to stick to a surface but can be removed and repositioned. Importantly, the product has air release channels for easy, bubble free installation. It is provided with a polyethylene-coated paper backing that allows the vinyl to peel from the backing in large sheets without tearing or folding.

Other characteristics of the material include the ability to affect the stickiness of the adhesive using heat. This allows the material to be positioned and repositioned on the lure until the adhesive is “fixed” using firm pressure or heat. The adhesive will also release at temperature and can be easily peeled off of a lure with exposure to heat or flame above 100° F. The vinyl also takes color very well and highly detailed images can be created on the vinyl using standard ink jet printers. Finally, the vinyl can be scored or cut without cutting the backing material. This allows the user to print an image on the vinyl, score or cut around the image but leave the image intact on the backing so it can be used at a later time.

Certain vinyl products are well suited to this application generally referred to as premium cast vinyl which conforms to curved surfaces. In addition to the 3M™ product preferred, other manufacturers provide products that can be used, including: Avery Supreme Wrap Film, ORACAL 970RA, PrismJET 230 Ultra, ORAJET 3551 RA, 3751RA and 3951 RA, Avery EZRS “Supercast”. This list is not exhaustive and it is understood that any vinyl product that holds printed images could potentially be used for the inventive device and method.

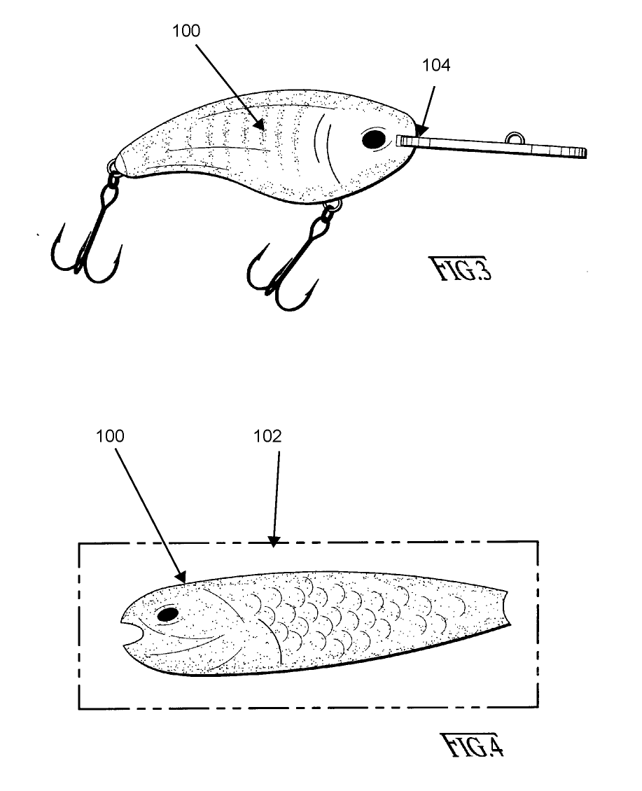

Once a lure 104 has been selected for its size, configuration and desirability, a set of printed images 100 can be created for use with that specific lure. An entire palette of colors and designs can be created and provided on a sheet shown in FIG. 6, or multiple sheets of vinyl material. This allows the angler to take a very large selection of images to change lure appearance at a cost far below buying individual lures. Moreover, the vinyl sheets can be provided in notebooks that are easy to use and store. The change from a commercially available lure, shown in FIG. 2 to the decorated lure with the inventive vinyl image, shown in FIG. 3 is significant. It has been shown that fish are much more likely to bite on the decorated lure than the undecorated lure.

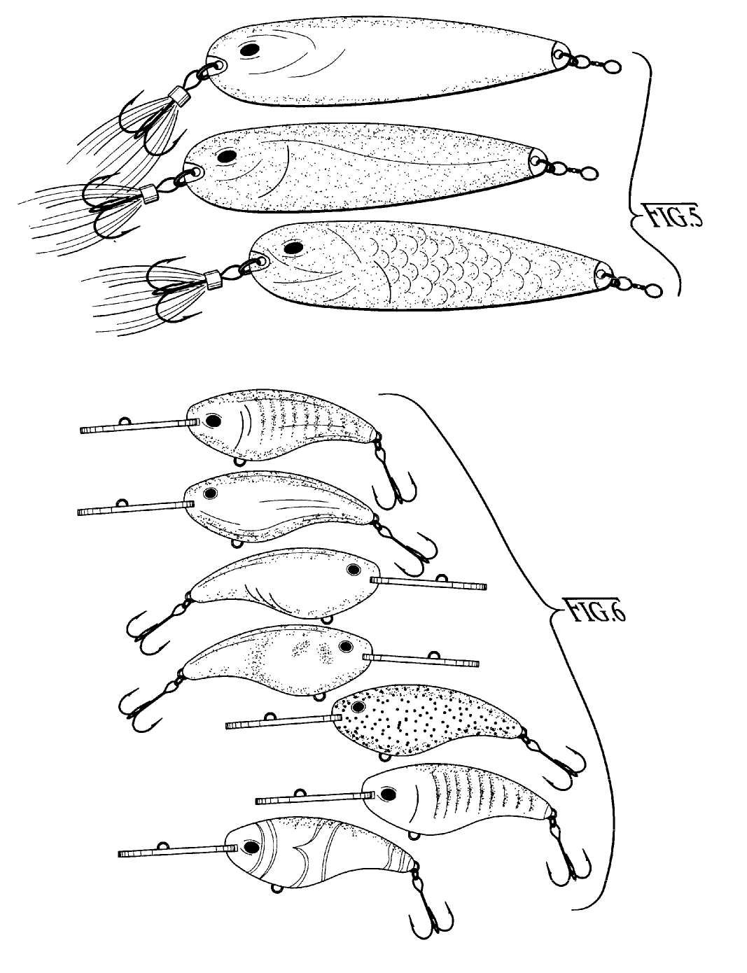

It is understood that this inventive product and method can be adapted to many kinds of fishing lures for both freshwater and saltwater fishing. The change to the appearance of a lure is dramatic, such as the change in appearance to spoon lures shown in FIGS. 4 and 5.

One platform for delivering the product is to develop sets of lure images and make them available via computer download or on electronic media. Sheets of vinyl templates are offered for sale with lure-shaped sections which are scored or cut in the vinyl. Images are selected from the electronic media and the user prints out the desired images via ink-jet printer onto the vinyl sheets. Obviously, the user could cut the images from an un-scored sheet of vinyl.

The method for performing this invention includes the steps of selecting a lure, creating at least one image for a fish attractant to be applied to the lure, printing the selected image on a flat vinyl material, cutting the image from the vinyl material and applying the image to the lure. The method for using the inventive product includes the steps of selecting a printed image from a set of provided images, applying the image to one side of a fishing lure, applying a second printed image to the opposite side of the lure, fish with the lure, removing the images from the lure when finished.

Comprise, include, and/or plural forms of each are open ended and include the listed parts and can include additional parts that are not listed. And/or is open ended and includes one or more of the listed parts and combinations of the listed parts.

Importantly, the inventive assembly can be configured in many sizes for fitting fishing lures of practically any size and configuration. Moreover, the device can be manufactured from a variety of materials or combination of materials without departing from the scope of this patent. One skilled in the art will realize that the present disclosure may be embodied in other specific forms without departing from the spirit or essential characteristics thereof. The foregoing embodiments are therefore to be considered in all respects illustrative rather than limiting of the present disclosure. Scope of the present disclosure is thus indicated by the appended claims, rather than by the foregoing description, and all changes that come within the meaning and range of equivalency of the claims are therefore intended to be embraced therein.

What is claimed is:

1. A device for changing the appearance of a fishing lure comprising: a visual image printed onto a first surface of a substantially planar material, wherein the planar material has an adhesive on a second surface opposite the first surface for adhering the material to the fishing lure.

2. The device of claim 1 wherein the image is selected from a group of images comprising images of: baitfish, insects, crustaceans, amphibians, reptiles, mammals, or random geographic shapes.

3. The device of claim 1 wherein the image is printed onto the first surface of the material with ink jet printing.

4. The device of claim 1 wherein the material is provided with a releasable backing.

5. The device of claim 4 wherein the material is scored around the image without cutting through the backing.

6. The device of claim 1 wherein the material is vinyl.

7. The device of claim 1 wherein multiple images are printed on a sheet of material.

8. A device for changing the appearance of a fishing lure comprising: an image of a fishing bait printed onto a sheet of vinyl material, wherein the vinyl material is provided with an adhesive side and a removable backing, and the vinyl is scored around the periphery of the image so that the image can be removed from the backing and applied to the fishing lure.

9. A method for changing the appearance of a fishing lure, comprising the steps of selecting a fishing lure, creating at least one image for a fish bait to be applied to the lure, printing the selected image on a paper backed vinyl material, scoring around the image through the vinyl, removing the image bearing vinyl material from the backing and applying the image to the lure.

10. The method of claim 9 adding the step of applying a second image to the lure.

11. A method for using the device of claim 1, comprising the steps of selecting an image from a set of provided images, applying the image to one side of a fishing lure, applying a second printed image to the opposite side of the lure, fishing with the lure, and removing the images from the lure when finished.
